(19) United States
(12) Patent Application Publication
(10) Pub. No.: US 2007/0139187 A1
(43) Pub. Date: Jun. 21, 2007

(54) Microchip monitoring system and method

(76) Inventor: Paul J. Dobosz, Noblesville, IN (US)

Correspondence Address: DELPHI TECHNOLOGIES, INC., M/C 480-410-202, PO BOX 5052, TROY, MI, 48007, US

(21) Appl. No.: 11/311,721

(22) Filed: Dec. 19, 2005

(51) Int. Cl. G08B 1/08

(52) U.S. Cl. 340/539.11

(57) ABSTRACT

A microchip monitoring system that monitors the status and/or location of a person, animal or asset carrying a small, discrete microchip. The microchip monitoring system generally includes a microchip and a portable communications device both attached to the object being monitored, a communications device coupled to the portable communications device via a local area link, a wide area network and a system back-end. The portable communications device acquires electronic information from the microchip and then conveys that information to the system back-end via the local area link and the wide area network. This allows the system back-end to monitor the status and/or location of one or more microchips without the monitored objects having to carry cumbersome communications hardware.

### FIELD OF THE INVENTION

The present invention generally relates to a monitoring system, and more particularly, to a microchip monitoring system that utilizes one or more wireless links to convey information from a microchip attached to a person, animal or asset to a system back-end.

### BACKGROUND OF THE INVENTION

There has been a recent rise in popularity among tracking and monitoring systems that utilize small electronic tags or beacons, most commonly, radio frequency identification (RFID) tags or beacons. Their small, versatile and low power-consuming nature make them ideal for use in certain wireless tracking and monitoring systems, which explains why they have been utilized in a wide variety of applications ranging from cross-country package tracking to retail store inventory monitoring.

For example, U.S. Pat. No. 6,700,533 issued Mar. 2, 2004 to Werb et al. discloses a system for tracking outdoor objects such as tractor trailers. According to this system, a tag having a GPS receiver is attached to the item to be tracked and transmits uncorrected position and satellite data back to a base station when the tag and base station are in range of each other. In the event that the tag is out of range of the base station, the tag periodically calculates and archives its position so that it can communicate that information to the base station at a later time.

There are other examples of monitoring and tracking systems utilizing small electronic tags attached to a particular item, including those examples disclosed in U.S. Patent Application Publication Nos. 2005/0134459 published Jun. 23, 2005 and 2005/0149358 published Jul. 7, 2005.

### SUMMARY OF THE INVENTION

According to one aspect of the invention, there is provided a microchip monitoring system that includes a microchip for storing electronic information, a portable communications device having a wireless microchip reader and a first wireless local area transceiver, a communications device having a second wireless local area transceiver and a wide area network connection, a wide area network and a system back-end. The first and second wireless local area transceivers are coupled to one another via a local area link, the wide area network connection is coupled to the wide area network, and the wide area network is coupled to the system back-end so that it can monitor the status of the microchip.

According to another aspect of the invention, there is provided a method of monitoring the status of an implanted microchip, that generally includes the steps of: (a) implanting a microchip for storing electronic information on a person, animal or asset, (b) affixing a portable communications device to the person, animal or asset on which the microchip is implanted, (c) providing a communications device for wirelessly communicating with the portable communications device; and (d) providing a system back-end for communicating with the communications device.

Some examples of objects, features and advantages of this invention include, but are certainly not limited to, providing a microchip monitoring system that: monitors the status and/or location of a person, animal or asset without that object having to carry cumbersome communications hardware that would otherwise be required for direct communication with a wide area network, utilizes a mobile-to-mobile connection to provide a dynamic and versatile coverage area for monitoring a microchip, obtains electronic information such as biometrical data from a microchip implanted on a person or animal, uses warning signals or other alarms to indicate when either a microchip and microchip reader are separated or when a portable communications device is about to exceed the boundary of the local area link established with a communications device, utilizes a wide area network having a reliable, relatively low-cost satellite network to established a data link with a system back-end, monitors the status and/or location of a plurality of different microchips, and provides a design that is of relatively simple design, economical manufacture and operation, is serviceable, and has a long and useful life in service, to name but a few.

Of course, it is not necessary that a particular embodiment of the present invention incorporate each and every one of the above-listed objects, features and advantages, as that list is simply a recitation of some of the qualities of various embodiments of the present invention. Moreover, a particular embodiment of the present invention may have additional objects, features and advantages beyond the exemplary ones listed above.

### BRIEF DESCRIPTION OF THE DRAWING

These and other objects, features and advantages of the present invention will be apparent from the following detailed description of the preferred embodiments and best mode, appended claims and accompanying drawing, in which:

FIG. 1 is a block diagram of an embodiment of a microchip monitoring system utilizing a local area link with a mobile-to-mobile connection.

### DETAILED DESCRIPTION OF PREFERRED EMBODIMENTS

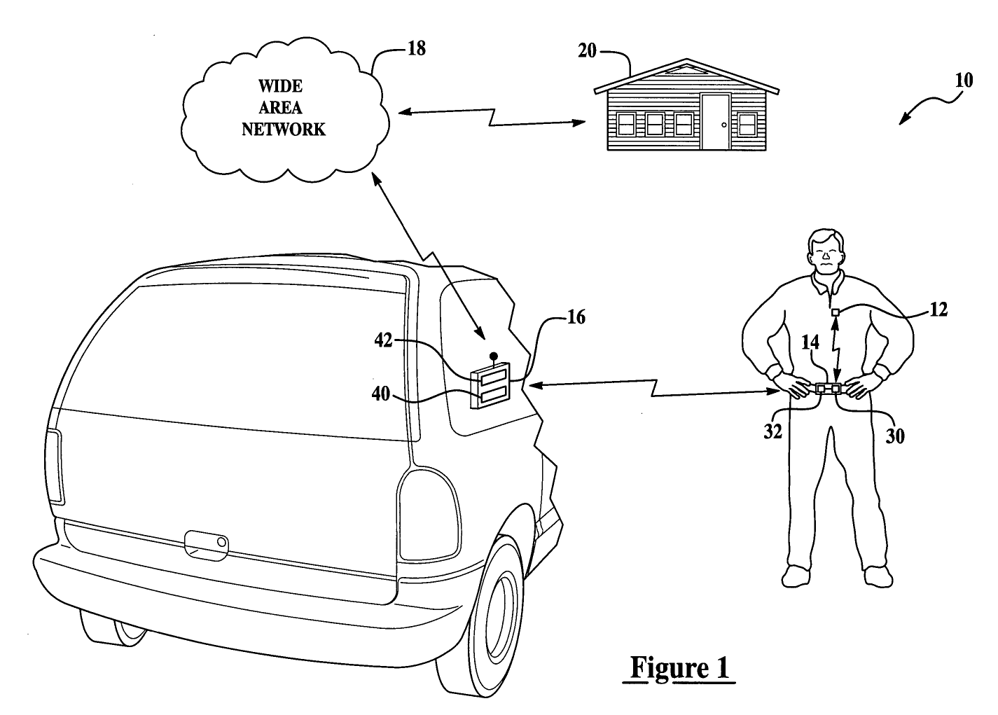

Referring to FIG. 1, there is shown an embodiment of a microchip monitoring system 10 that monitors the status and/or location of a person, animal or asset carrying a small, discrete microchip 12. Microchip monitoring system 10 can be utilized in a wide variety of applications, including monitoring children and pets for safety purposes, monitoring soldiers on a battlefield, monitoring high profile individuals operating in parts of the world where they may be in danger of being kidnapped, and monitoring prisoners in a prison facility, to name but a few. The microchip monitoring system 10 generally includes a small microchip 12, a portable communications device 14, a portable or stationary communications device 16, a wide area network (WAN) 18 and a system back-end 20.

Microchip 12 is a small electronic component capable of storing electronic information and wirelessly communicating that information to portable communications device 14. Preferably, microchip 12 is a radio frequency identification (RFID) component having an internal antenna which enables it to receive and respond to radio frequency (RF) queries from portable communications device 14, and can be of the passive type (requires no internal power) or the active type (requires internal power). Passive RFID microchips utilize some of the energy of the query signal in order to generate an RF response signal, explaining why they require no internal power source. Accordingly, passive RFID microchips can only transmit an RF signal after receiving an RF signal. Active RFID microchips, on the other hand, include their own internal power source and are therefore capable of transmitting RF signals at any time; not just in response to a query signal. Microchip 12 can store a wide variety of information, ranging from a relatively simple unique identification number that uniquely identifies the particular person, animal or asset to which it is attached, to more complex types of data such as human or animal biometrical data. Moreover, the microchip can be attached to a person, animal or asset by one of numerous methods, including non-invasive methods where the microchip is simply located in a pocket or compartment of some type, as well as more invasive techniques such as implanting it below the skin of a person or animal so that it can sense and store certain biometrical readings and then communicate those readings to portable communications device 14. Examples of suitable RFID microchips include those sold by Verichip Corporation of Palm Beach, Fla.

Portable communications device 14 is preferably attached to the person, animal or asset carrying the microchip 12 so that it can read the electronic information stored on the microchip and transmit that information to communications device 16 via a wireless local area link (LAL). According to a preferred embodiment, portable communications device 14 is a small inconspicuous device that can be worn as a personal electronics device such as a pager, PDA, cellular phone, wristwatch, etc., and includes an integrated wireless microchip reader 30 and a wireless local area transceiver 32. In the example where microchip 12 is a passive RFID component, wireless microchip reader 30 is preferably a low power RFID transceiver that wirelessly acquires information from the microchip by exciting it with an RF signal. This data acquisition usually works well so long as the microchip and reader are within a certain proximity of each other. If, however, microchip reader 30 and microchip 12 become separated from each other such that they are unable to communicate, then wireless local area transceiver 32 could send a warning or separation signal to communications device 16. This warning signal may be particularly helpful in certain applications, such as the prisoner monitoring example provided above, where it useful to know if the wireless microchip reader becomes separated from the microchip. Numerous types of wireless microchip readers are available, including the MF-RC530model offered by Philips. Of course, other, non-RF technologies known in the art could also be used to wirelessly pass electronic information from the microchip to the microchip reader as well.

Wireless local area transceiver 32 utilizes one of a number of different short range wireless communications protocols to transfer information acquired by wireless microchip reader 30 to communications device 16. In this sense, transceiver 32 and communications device 16 establish a wireless local area link between the two components that allows for data communication so long as they are within a certain proximity of each other. Because transceiver 32 only has to communicate with communications device 16 over a short range (as opposed to communicating with a distant satellite or tower), portable communications device 14 is preferably lightweight, inconspicuous and requires little power. If portable communications device 14 approaches the boundary of the local area link established with communications device 16, then device 14 can either send a warning signal to the user to alert them that they are nearing the outer limits of the wireless link and that further separation from device 16 will likely result in a loss of communications, and/or send a warning signal to communications device 16 to alert the system that the portable device 14 is no longer in communications with device 16. The portable communications device 14 can also be provided with additional features such as an integrated cellular phone for voice communication, a built in global positioning system (GPS) receiver, a panic button allowing the user to alert the system of some type of problem, memory devices for storing acquired biometrical and other data from microchip 12, etc. Some examples of suitable wireless protocols include, but are not limited to, Bluetooth, Zigbee, Wi-Fi, infrared or others known to those skilled in the art, and an example of an acceptable wireless transceiver is the CXN-1000chip sold by Sony Semiconductor.

Communications device 16 is a compact, integrated piece of hardware that includes a wireless local area transceiver 40 for communicating with one or more transceiver(s) 32, and a wide area network connection 42 for connecting with wide area network 18. Communications device 16 can be installed in a mobile setting such as in a vehicle, tank, boat, plane, etc. such that the local area link between wireless transceivers 40 and 32 is a ‘mobile-to-mobile’ connection that enables the wireless coverage area to change with the location of communications device 16. Alternatively, communications device 16 can be installed in a home, building or other stationary setting such that the local area link between transceivers 40 and 32 is a ‘fixed-to-mobile’ connection where transceiver 40 only provides wireless interconnectivity over a specific, generally static geographic area. The mobile-to-mobile connection, which is particularly suitable for vehicle-mounted communications devices 16, enables system 10 to monitor microchip 12 over a wider, changing area without portable communications device 14 having to include bulky, high-energy consuming communications equipment that would otherwise be necessary if that device were to communicate directly with wide area network 18.

Wide area network connection 42 connects communications device 16 with wide area network 18 so that the information stored on microchip 12, as well as any other pertinent information used by components 12-16, may be conveyed to system back-end 20. In the example of a mobile-to-mobile connection, wide area network connection 42 preferably includes some type of wireless communications hardware so that communications device 16 may move around and still maintain contact with wide area network 18. For instance, if communications device 16 is expected to stay within a relatively small geographic area such that it is covered by some type of wireless service such as Wi-Max, then the wireless communications hardware for connection 82 could include some type of short-to medium-range wireless transceiver. If, on the other hand, communications device 16 is expected to go outside of a predetermined area, as in the case where it is mounted on a vehicle, then wide area network connection 42 preferably includes an integrated satellite transceiver to transmit and receive data with one or more satellites that are part of wide area network 18. An example of a suitable satellite network is the data only communications network owned and operated by Orbcomm, which utilizes a constellation of thirty or more low earth orbit (LEO) satellites along with a global network of ground stations to provide cost-effective tracking, monitoring and messaging capabilities throughout the world. By using a data-only satellite network, dependable and affordable satellite-based (as opposed to cellular-based) data communication can be established anywhere in the world, without the additional expense associated with voice communication circuitry. One type of data transceiver that may be used for the satellite communication is a DS-100 or DS-300 satellite modem offered by the assignee of the present application, Delphi Corporation. In the case where transceivers 40 and 32 have established a fixed-to-mobile connection, then wide area network connection 42 can use one of a number of well known technologies to connect with wide area network 18. These technologies include, but are not limited to, connections utilizing standard telephone lines, DSL lines, broadband cable lines, power lines, fiber optic lines, etc.

Wide area network 18 conveys information between communications device 16 and system back-end 20 and can broadly include any number of different wired and wireless components, including communications networks, base stations, towers and/or satellites. Because the specific arrangement and composition of the wide area network 18 is not directly relevant and because wide area networks are well known in the art, a further description is omitted.

System back-end 20 generally monitors the status of microchip 12, as well as all of the other components of the microchip monitoring system 10. For instance, if a warning signal is sent from portable communications device 14 indicating that the microchip and the portable communications device have been separated and are no longer in communication with one another, then system back-end 20 could be programmed to respond to such a warning signal. This response may include taking measures such as notifying other users of the system that a microchip/reader separation has occurred for the microchip in question, or it may involve establishing a voice link with portable communications device 14 to determine what the problem is. These are, of course, only some of the possible actions that the system may take, as those skilled in the art will appreciate. The system back-end can either be fully automated, staffed by employees, or operated according to some combination thereof.

In operation, microchip monitoring system 10 monitors the status and/or location of one or more microchips 12, each of which is attached to a person, animal or asset of interest. According to one exemplary embodiment, microchip monitoring system 10 monitors numerous soldiers on a battlefield and generally includes a number of implanted microchips 12 and portable communications devices 14, a single mobile-to-mobile communications device 16, a wide area network 18 and a system back-end 20. Each soldier is affixed with an RFID microchip 12 that is implanted just below the skin and stores a unique soldier identification number as well as various types of biometrical data about the soldier. Each soldier also carries a portable communications device 14 that includes a built in GPS receiver for determining the soldier's position on the battlefield. Device 14 may be a stand alone electronic device carried with the rest of the soldier's gear or it may be integrated within some other piece of electronic equipment. Assuming that microchip 12 and portable communications device 14 are within a suitable range or each other (typically about 3-6 feet), the portable communications device will periodically query and acquire the stored electronic information from the microchip. As previously explained, if microchip 12 and device 14 become separated such that they are unable to communicate or if the soldier (and thus portable communications device 14) approaches the boundary of the local area link with device 16, then a warning signal is sent.

Once portable communications device 14 has acquired the electronic data stored on microchip 12, it sends that information along with a GPS-determined position reading to communications device 16. In this particular embodiment, communications device 16 is mounted in a tank or other vehicle acting as a mobile command and control center such that a mobile-to-mobile connection is established with portable communications device 14. In this way, the tank-mounted communications device 16 is able to communicate with each of the portable communications devices 14 carried by the different soldiers. Because of the mobile-to-mobile connection of the local area link established between communication devices 14 and 16, device 16 is able to move with the soldiers and thereby maintain connectivity over a large geographic area even though the local area link is a short-to medium-range link. Preferably, communications device 16 has a satellite transceiver built in for communication with a remotely located system back-end 20 via wide area network 18. However, it is possible for communications device 16 to be wired or otherwise connected to some type of central control unit also mounted in the tank such that the control unit can monitor the status and location of all of the soldiers without requiring further communication.

It will thus be apparent that there has been provided a microchip monitoring system that allows for monitoring the status and/or location of a microchip attached to a person, animal or asset, as well as a method of operation, which achieve the aims and advantages specified herein. It will of course be understood that the foregoing description is only of preferred exemplary embodiments, and that the invention is not limited to the specific embodiments shown.

I claim:

1. A microchip monitoring system, comprising:
a microchip for storing electronic information;
a portable communications device having a wireless microchip reader for obtaining said electronic information and a first wireless local area transceiver;
a communications device having a second wireless local area transceiver coupled to said first transceiver via a local area link, and a wide area network connection;
a wide area network coupled to said wide area network connection; and
a system back-end coupled to said wide area network, wherein said system back-end monitors the status of said microchip.

2. The microchip monitoring system of claim 1, wherein said microchip is a passive radio frequency identification (RFID) component.

3. The microchip monitoring system of claim 1, wherein said electronic information includes an unique identification number.

4. The microchip monitoring system of claim 1, wherein said microchip is implanted and said electronic information includes biometrical data.

5. The microchip monitoring system of claim 1, wherein said system includes a plurality of microchips and portable communications devices each communicating with said communications device via a separate local area link.

6. The microchip monitoring system of claim 1, wherein said portable communications device is a small inconspicuous device worn on the person, animal or asset carrying said microchip.

7. The microchip monitoring system of claim 1, wherein said portable communications device sends a warning signal if said microchip and said microchip reader become separated such that they are unable to communicate.

8. The microchip monitoring system of claim 1, wherein said portable communications device includes a global positioning system (GPS) receiver.

9. The microchip monitoring system of claim 1, wherein said local area link between said first and second wireless local area transceivers utilizes at least one of the following short range wireless communications protocols: Bluetooth, Zigbee and Wi-Fi.

10. The microchip monitoring system of claim 1, wherein said communications device sends a warning signal if said portable communications device approaches the boundary of said local area link.

11. The microchip monitoring system of claim 1, wherein said portable communications device includes a panic button for alerting said system of a problem.

12. The microchip monitoring system of claim 1, wherein said communications device is installed in a generally mobile setting such that said local area link between said first and second wireless transceivers is a mobile-to-mobile connection.

13. The microchip monitoring system of claim 12, wherein said wide area network connection includes a short- to medium-range wireless transceiver for connecting with said wide area network.

14. The microchip monitoring system of claim 12, wherein said wide area network connection includes a satellite transceiver for connecting with said wide area network.

15. The microchip monitoring system of claim 1, wherein said communications device is installed in a generally stationary setting such that said local area link between said first and second wireless transceivers is a fixed-to-mobile connection.

16. The microchip monitoring system of claim 15, wherein said wide area network connection utilizes at least one of a standard telephone line, a DSL line, a broadband cable line, a power line and a fiber optic line for connecting with said wide area network.

17. A method of monitoring the status of an implanted microchip, comprising the steps of:
(a) implanting a microchip for storing electronic information on a person, animal or asset;
(b) affixing a portable communications device to the person, animal or asset on which said microchip is implanted so that said portable communications device may wirelessly acquire said electronic information from said microchip;
(c) providing a communications device for wirelessly communicating with said portable communications device via a local area link; and
(d) providing a system back-end for communicating with said communications device via a wide area network.

18. The method of claim 17, wherein said electronic information includes biometrical data on the person, animal or asset on which said microchip is implanted.

19. The method of claim 17, wherein said method further includes the step of sending a warning signal if either i) said microchip and said portable communications device become separated such that they are unable to communicate, or ii) said portable communications device approaches the boundary of said local area link.

20. The method of claim 17, wherein said method is used to monitor the position and status of soldiers on a battlefield.
